(19) United States
(12) Patent Application Publication
(10) Pub. No.: US 2025/0156296 A1
(43) Pub. Date: May 15, 2025

(54) MEMORY ALLOCATION FOR A BENCHMARK TEST

(71) Applicant: Micron Technology, Inc., Boise, ID (US)

(72) Inventors: Luca Porzio, Casalnuovo (IT); Nicola Colella, Capodrise (IT); Rakeshkumar Dayabhai Vaghasiya, Hyderabad (IN); Deping He, Boise, ID (US)

(21) Appl. No.: 18/929,369

(22) Filed: Oct. 28, 2024

Related U.S. Application Data
(60) Provisional application No. 63/548,320, filed on Nov. 13, 2023.

(51) Int. Cl. G06F 11/34; G06F 9/50

(52) U.S. Cl. CPC G06F 11/3428; G06F 9/5016; G06F 9/5022; G06F 11/3419

(57) ABSTRACT

Methods, systems, and devices for memory allocation for a benchmark test are described. A memory system may be configured to allocate and deallocate portions of a volatile memory for specific uses based on detecting the occurrence of a benchmark testing operation. For example, the memory system may be configured to detect the occurrence of a benchmark testing operation based on the occurrence of one or more conditions. After detecting the benchmark testing operation, the memory system may deallocate a portion of the volatile memory associated with multiple-level cell accesses and may allocate (e.g., reallocate) the portion for storing additional logical-to-physical mappings.

### CROSS REFERENCE

The present application for patent claims priority to U.S. Patent Application No. 63/548,320 by Porzio et al., entitled “MEMORY ALLOCATION FOR A BENCHMARK TEST,” filed Nov. 13, 2023, which is assigned to the assignee hereof, and which is expressly incorporated by reference in its entirety herein.

### TECHNICAL FIELD

The following relates to one or more systems for memory, including memory allocation for a benchmark test.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not- and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports memory allocation for a benchmark test in accordance with examples as disclosed herein.

FIGS. 2A and 2B show examples of a system that supports memory allocation for a benchmark test in accordance with examples as disclosed herein.

FIG. 3 shows an example of a process flow that supports memory allocation for a benchmark test in accordance with examples as disclosed herein.

FIG. 4 shows a block diagram of a memory system that supports memory allocation for a benchmark test in accordance with examples as disclosed herein.

FIG. 5 shows a flowchart illustrating a method or methods that support memory allocation for a benchmark test in accordance with examples as disclosed herein.

### DETAILED DESCRIPTION

A benchmark test may be performed on a memory system to test one or more parameters. For example, a benchmark test may test parameters such as latency, bandwidth, temperature, and power consumption while accessing one or more non-volatile memory cells of the memory system. To access the non-volatile memory cells, the memory system (e.g., a memory system controller) may utilize a table that stores mappings between logical addresses and physical addresses of the memory system. In some cases, a portion of the mapping table may be stored in a volatile memory of the memory system to decrease latency when accessing the mappings.

However, when performing a benchmark test, a relatively large quantity of data stored to the non-volatile memory may be accessed, resulting in a relatively high quantity of mappings being transferred between the non-volatile memory and the volatile memory. Because the volatile memory may be relatively small, the portion of the mapping table stored to the volatile memory may store a relatively small subset of the mappings associated with the benchmark test. Increasing the size of the volatile memory to store a larger quantity of mappings associated with the benchmark test may be relatively expensive, or may occupy an undesirably large portion of the memory system. Thus, a memory system having a memory (e.g., a volatile memory) that is able to store a relatively large quantity of mappings associated with a benchmark test without adding undesirable cost or occupying an undesirably large portion of the system may be desirable.

A memory system having a volatile memory that is configured to store a relatively large quantity of mappings associated with a benchmark test while reducing undesirable cost or without occupying an undesirably large portion of the system is described herein. In some instances, the memory system may include a volatile memory and a non-volatile memory. The non-volatile memory may include memory cells for storing a single bit of data (e.g., single-level cells (SLCs)) and for storing two or more bits of data (e.g., multiple-level cells, such as multi-level cells (MLCs), triple-level cells (TLCs), quad-level cells (QLCs)). The memory system may include one or more cursors for managing accesses to the SLCs and multiple-level cells. For example, when data is read from or written to a SLC or multiple-level cell, data may be temporarily stored to a dedicated portion of the volatile memory before being read to a host system or written to the SLC or multiple-level cell.

The memory system may include a component (e.g., a benchmark detector) that is configured to detect when a benchmark testing operation is being performed. For example, the benchmark detector may detect that a random read benchmark test is being performed based on the occurrence of one or more conditions. When a benchmark testing operation is detected, the memory system may deallocate the portion of the volatile memory dedicated for multiple-level cell accesses by flushing its contents. The memory system may then allocate the same portion of the volatile memory for storing address mappings between logical addresses and physical addresses. Accordingly, the volatile memory may then be able to store a relatively large quantity of mappings without the system incurring additional costs or occupying an undesirably large portion of the memory system. Moreover, by increasing the size of the volatile memory for storing address mappings, the system's latency and overall performance may be improved during the benchmark test.

In addition to applicability in memory systems as described herein, techniques for memory allocation for a benchmark test may be generally implemented to improve the performance (including gaming) of various electronic devices and systems. Some electronic device applications, including gaming and other high-performance applications, may be associated with relatively high processing requirements while also benefitting from relatively quick response times to improve user experience. As such, increasing processing speed, decreasing response times, or otherwise improving the performance electronic devices may be desirable. Implementing the techniques described herein may improve the performance of electronic devices by detecting a benchmark test and reconfiguring a volatile memory to support relatively high performance during the benchmark test, which may result in decreased processing or latency times, improved response times, or otherwise improved user experience, among other benefits.

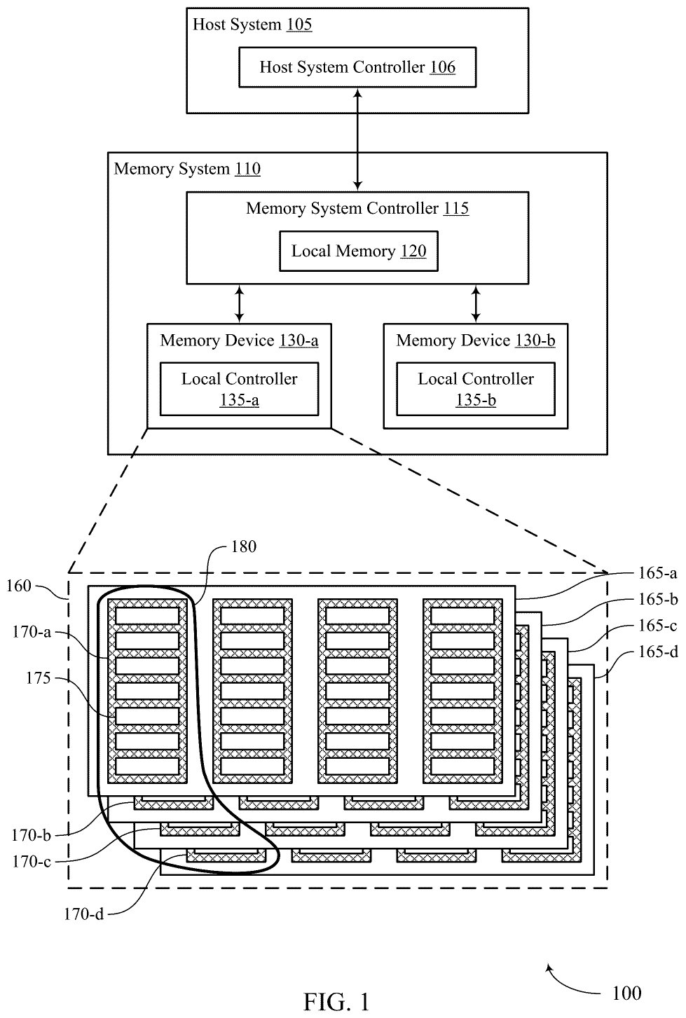

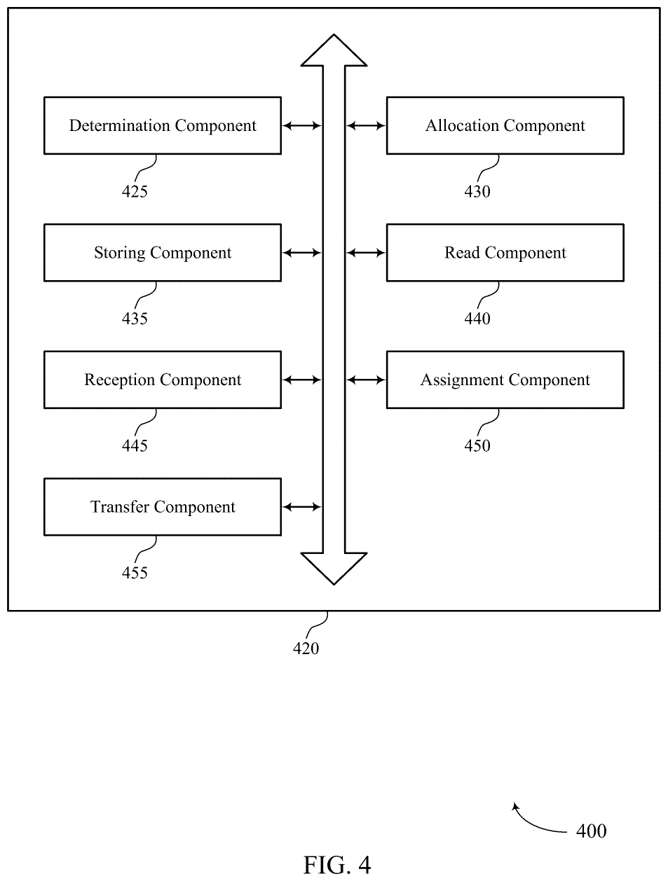

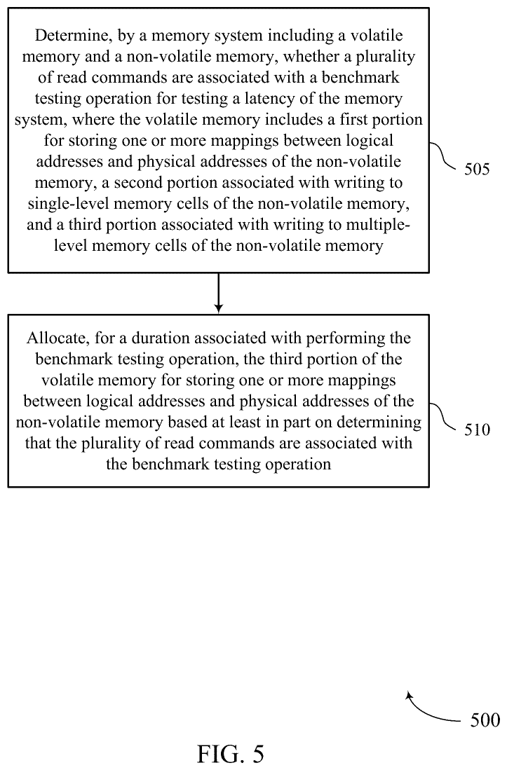

Features of the disclosure are initially described in the context of systems, devices, and process flows with reference to FIGS. 1 through 3. These and other features of the disclosure are further illustrated by and described in the context of an apparatus diagram and flowchart that relate to memory allocation for a benchmark test with reference to FIGS. 4 and 5.

FIG. 1 shows an example of a system 100 that supports memory allocation for a benchmark test in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells. Additionally, or alternatively, a NAND memory device 130 may include memory cells configured to each store multiple bits of information, which may be referred to as multi-level cells if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support memory allocation for a benchmark test. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some instances, the memory system 110 may include a volatile memory and a non-volatile memory. For example, the memory device 130-a may include both a volatile memory and a non-volatile memory. The non-volatile memory may include memory cells for storing a single bit of data (e.g., SLCs) and for storing two or more bits of data (e.g., multiple-level cells). The memory system 110 may include one or more cursors for managing accesses to the SLCs and multiple-level cells. For example, when data is read from or written to a SLC or multiple-level cell, data may be temporarily stored to a dedicated portion of the volatile memory before being read to the host system 105 or written to the SLC or multiple-level cell.

The memory system 110 may include a component (e.g., a benchmark detector) that is configured to detect when a benchmark testing operation is being performed. For example, the benchmark detector may detect that a random read benchmark test is being performed based on the occurrence of one or more conditions. When a benchmark testing operation is detected, the memory system 110 may deallocate the portion of the volatile memory dedicated for multiple-level cell accesses by flushing its contents. The memory system 110 may then allocate the same portion of the volatile memory for storing L2P mappings. Accordingly, the volatile memory may then be able to store a relatively large quantity of mappings without the memory system 110 incurring additional costs or occupying an undesirably large portion of the memory system 110. Moreover, by increasing the size of the volatile memory for storing address mappings, the latency and overall performance of the memory system 110 may be improved during the benchmark test.

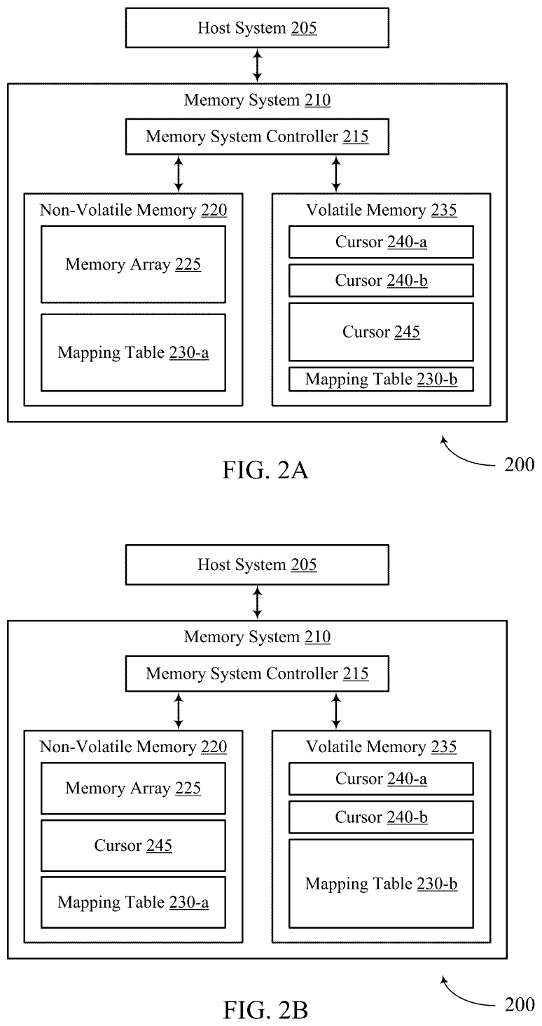

FIGS. 2A and 2B show examples of a system 200 that supports memory allocation for a benchmark test in accordance with examples as disclosed herein. The system 200 may implement aspects of a system 100, as described with reference to FIG. 1. For example, the system 200 may include a host system 205 and a memory system 210, which may be examples of a host system 105 and a memory system 110, as described with reference to FIG. 1. FIG. 2A illustrates an example of the system 200 before detecting a benchmark test at the memory system 210, and FIG. 2B illustrates an example of the system 200 after reconfiguring a volatile memory 235 to support performing the benchmark test. As described herein, by increasing the size of the volatile memory 235 for storing address mappings, the latency and overall performance of the memory system 210 may be improved during the benchmark testing operation.

The system 200 may include a memory system 210 coupled with a host system 205. The memory system 210 may include a memory system controller 215, which may be an example of a memory system controller 115, as described with reference to FIG. 1. The memory system controller 215 may be configured to perform operations on the memory system 210 in accordance with commands received from the host system 205. The memory system 210 may include a benchmark detector, which may be included within the memory system controller 215 (e.g., as firmware) or may be coupled with the memory system controller 215 (e.g., as a standalone hardware component, which is not shown). The benchmark detector may be configured to determine whether a benchmark test has been initiated at the memory system 210. In some cases, the host system 205 may initiate the benchmark test to test one or more performance characteristics of the memory system 210, and the benchmark detector may detect the occurrence of the testing operation based on one or more characteristics of the data received from the host system 205.

In some cases, the benchmark detector may determine whether the system 200 is performing the benchmark test based on commands received from the host system 205. For example, the benchmark detector may compare a quantity of read commands to a quantity of write commands received from the host system 205 to determine whether the benchmark test is being performed. In some such examples, the benchmark detector may detect the occurrence of the benchmark test based on determining that a difference between the quantity of read commands and the quantity of write commands satisfies a threshold, or that the quantity of read commands or the quantity of write commands satisfy respective thresholds. For example, a random read benchmark testing operation may be detected if a relatively large quantity of read commands are received from the host system 205 (e.g., relative to the quantity of write commands received).

In other examples, the benchmark detector may detect the occurrence of the benchmark test based on identifying an absence of write commands. In some examples, the benchmark detector may detect the benchmark test based on determining sizes of data (e.g., data transfer size, chunk size) associated with the read commands are within a threshold range (e.g., each read command is a same size). For example, if the commands received from the host system 205 are similarly sized, then a benchmark testing operation may be detected.

In some cases, the benchmark detector may detect which type of benchmark test the system 200 is performing based on commands received from the host system 205. For example, a random read benchmark test may be associated with non-sequential read operations (e.g., read operations associated with non-sequential addresses of the memory system 210), and a sequential read benchmark test may be associated with sequential read operations (e.g., read operations associated with sequential addresses of the memory system 210). Accordingly, the benchmark detector may detect a random read benchmark test based on determining the quantity of read commands are non-sequential. Alternatively, the benchmark detector may detect a sequential read benchmark test based on determining the quantity of read commands are sequential.

In some cases, the benchmark detector may detect the occurrence of the benchmark testing based on determining a power state of the memory system 210. For example, the benchmark detector may determine whether the memory system 210 is in a high power state (e.g., a normal power state, an ON state) or a low power state (e.g., a hibernation state, a powered down state, an OFF state). In some cases, the benchmark detector may detect the occurrence of the benchmark test based on determining that the memory system 210 is not in the low power state (e.g., that the memory system 210 is in the high power state). In some examples, the benchmark detector may detect the benchmark test based on determining the memory system 210 has not received a command to enter the low power state.

FIG. 2A illustrates the memory system 210 including a non-volatile memory 220 (e.g., NAND memory), which may be an example of a memory device 130, as described with reference to FIG. 1. The non-volatile memory 220 may include a memory array 225 (e.g., a NAND array), which may include an array of non-volatile memory cells (e.g., NAND memory cells). The non-volatile memory 220 may include a mapping table 230-a, which may include address information for the memory array 225. For example, the mapping table 230-a may be an example of an L2P table that includes mappings between logical addresses (e.g., logical block addresses) and physical addresses (e.g., physical block addresses) of the memory array 225.

FIG. 2A illustrates the memory system 210 including a volatile memory 235 (e.g., SRAM memory, DRAM memory), which may be an example of a memory device 130, as described with reference to FIG. 1. The volatile memory 235 may include one or more cursors 240 (e.g., a second portion), which may be SLC cursors, for accessing SLCs of the memory array 225. For example, the volatile memory 235 may include cursor 240-a and cursor 240-b, which may each function as buffers for access commands associated with reading data from and writing data to the SLCs of the memory array 225. The volatile memory 235 may additionally include one or more cursors 245 (e.g., a third portion), which may be multiple-level cell cursors associated with reading data from and writing data to multiple-level cells of the memory array 225. As used herein, the multiple-level cell cursors may read data from or write data to memory cells associated with storing two or more bits of information, which may include MLCs, TLCs, and QLCs. In some examples, the one or more cursors 245 may be associated with a redundant array of independent NAND (RAIN) operation.

For example, the cursor 245 may be a cursor associated with reading data from or writing data to TLCs of the memory array 225. In some implementations, the cursor 245 may be associated with a relatively large size of the volatile memory 235. The volatile memory 235 may also include a mapping table 230-b (e.g., a first portion), which may include address mapping information for the memory array 225. The mapping table 230-b may be a portion of the mapping table 230-a, such that the mapping table 230-b may be an example of an L2P table including mappings between logical addresses (e.g., logical block addresses) and physical addresses (e.g., physical block addresses) of the memory array 225. In some implementations, the mapping table 230-b may be associated with a relatively small size of the volatile memory 235.

FIG. 2A illustrates an example of the system 200 during normal operation (e.g., no benchmark test being performed at the system 200), whereas FIG. 2B illustrates an example of the system 200 during a benchmark testing operation. For example, FIG. 2B illustrates the system 200 after the benchmark detector has detected the benchmark test is being performed, such that FIG. 2B illustrates the volatile memory 235 reconfigured to support performing the benchmark test. In some cases, after detecting the benchmark test, the cursor 245 (e.g., or one of the cursors 240) may be temporarily deallocated.

When the cursor 245 is deallocated, its contents may be stored (e.g., temporarily stored) to the non-volatile memory 220, which may free up space of the volatile memory 235. That is, the cursor 245 may be temporarily deallocated from the volatile memory 235 and allocated to the non-volatile memory 220. In some such cases, deallocating the cursor 245 may include disassociating a logical partition associated with the cursor 245 from a portion of the volatile memory 235, and reallocating the cursor 245 may include allocating a logical partition for the cursor 245 in the non-volatile memory 220. In some implementations, reallocating the cursor 245 to the non-volatile memory 220 may have a negligible effect on a storage capacity of the non-volatile memory 220.

In some cases, after deallocating the cursor 245 from the volatile memory 235, a size of the mapping table 230-b stored in the volatile memory 235 may be increased to support a relatively greater quantity of address information. For example, the portion of the volatile memory 235 previously associated with storing the cursor 245 may be reallocated to the mapping table 230-b. In some implementations, the size of the mapping table 230-b may be increased by a quantity corresponding to a size of the cursor 245.

In some such cases, increasing the size of the mapping table 230-b may support storing a relatively greater quantity of mappings, thereby supporting accessing a relatively greater quantity of data from the memory array 225 during the benchmark testing operation. Reconfiguring the volatile memory 235 to support accessing a relatively greater quantity of data may result in the memory system 210 performing relatively higher during the benchmark test. For example, the volatile memory 235 may support relatively low latency for accessing data associated with the mapping table 230-b (e.g., compared to accessing data using the mapping table 230-a in the non-volatile memory 220), thus the memory system 210 may have a capacity for accessing a relatively greater quantity of the data during performing the benchmark test, while maintaining the low latency associated with using the volatile memory 235.

In other cases, the benchmark detector may determine that the benchmark test is a sequential benchmark test. For example, the benchmark detector may determine that the LBAs of the read commands received from the host system 205 are sequential. In some instances, such a determination may be made based on a quantity (e.g., a threshold quantity) of sequential LBAs being received. When a sequential benchmark test is ongoing, the memory system controller 215 may begin preloading mappings to the mapping table 230-b (e.g., after deallocating the cursor 245 from the volatile memory 235).

Preloading mappings may refer to the memory system controller 215 loading mappings associated with subsequent, sequential LBAs to the mapping table 230-b before the associated command is received from the host system 205. Accordingly, when the associated command is received the mapping may already be stored to the mapping table 230-b, and the associated data may be read to the host system 205 with relatively low latency. As described herein, by increasing the size of the volatile memory 235 for storing address mappings, the latency and overall performance of the memory system 210 may be improved during the benchmark testing operation.

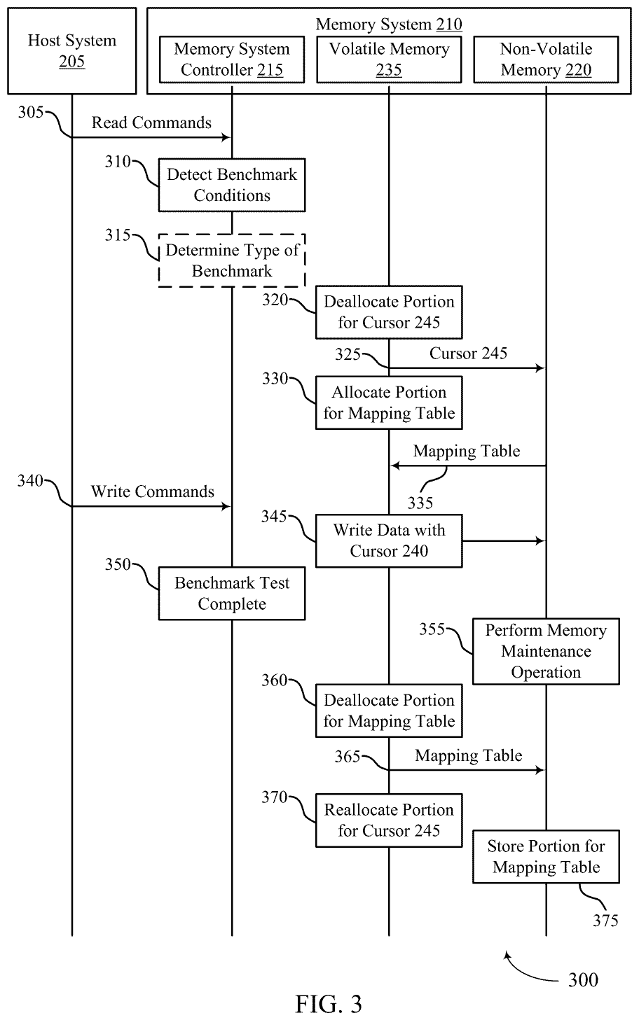

FIG. 3 shows an example of a process flow 300 that supports memory allocation for a benchmark test in accordance with examples as disclosed herein. The process flow 300 may illustrate aspects or operations of a system 200, as described with reference to FIGS. 2A and 2B, respectively. For example, the process flow 300 may depict operations at a host system 205 and a memory system 210 that includes a memory system controller 215, a volatile memory 235, and a non-volatile memory 220, as described with references to FIGS. 2A and 2B. As described herein, by increasing the size of the volatile memory 235 for storing address mappings, the latency and overall performance of the memory system 210 may be improved during the benchmark testing operation.

In the following description of the process flow 300, the methods, techniques, processes, and operations may be performed in different orders or at different times. Further, some operations may be left out of the process flow 300, or other operations may be added to the process flow 300. The process flow 300 illustrates operations associated with detecting a benchmark test and reconfiguring a volatile memory 235 to support performing the benchmark test, as described with reference to FIGS. 2A and 2B.

At 305, a quantity of read commands may be transmitted to the memory system controller 215. In some examples, the quantity of read commands may be transmitted by the host system 205.

At 310, one or more conditions associated with performing a benchmark test may be detected. In some examples, the conditions may be detected by the memory system controller 215. For example, a benchmark detector associated with the memory system controller 215 may determine that one or more conditions associated with performing a benchmark test have been satisfied. As described with reference to FIG. 2A, the benchmark detector may detect the benchmark test based on comparing command types received at the memory system (e.g., a quantity of read commands compared to a quantity of write commands), command sizes (e.g., data transfer sizes), power states of the memory system (e.g., hibernation), or a combination thereof. For example, the benchmark detector may determine that the quantity of read commands received at 305 satisfies a threshold, each of the read commands is a same size, no write commands have been received, the memory system 210 is not in a hibernation state, or a combination thereof, to determine whether the benchmark test is being performed.

At 315, a determination about whether the benchmark test is a random or sequential benchmark test may be made. In some examples, the determination may be made by the memory system controller 215 (e.g., by the benchmark detector). For example, the benchmark detector may determine that the read commands received at 305 are associated with sequential addresses and the benchmark detector may determine that the benchmark test is a sequential benchmark test. In another example, the benchmark detector may determine that the read commands received at 305 are associated with non-sequential addresses and the benchmark detector may determine that the benchmark test is a random benchmark test. As illustrated in FIG. 3, the benchmark detector may have determined that the benchmark test is a random benchmark test. Additionally, or alternatively, during the benchmark testing operation, data associated with the received read commands may be read from the non-volatile memory 220 to the host system 205 (e.g., by the memory system controller 215).

At 320, a cursor 245 may be deallocated from the volatile memory 235, as described with reference to FIG. 2A. For example, the cursor 245 (e.g., a logical partition associated with the cursor 245) may be removed from a portion of the volatile memory 235. The cursor 245 may be associated with writing data to multiple-level cells of the non-volatile memory 220.

At 325, the cursor 245 may be transferred to the non-volatile memory 220. That is, the data associated with the cursor 245 may be written (e.g., temporarily written) to one or more multiple-level cells of the non-volatile memory 220.

At 330, the portion of the mapping table may be allocated to the volatile memory 235, such that the volatile memory 235 may store the portion of the mapping table. The portion of the mapping table may be an addition to a portion of the mapping table already stored in the volatile memory 235 (e.g., mapping table 230-b, as described with reference to FIG. 2A).

At 335, a portion of a mapping table (e.g., a portion of a mapping table 230-a, as described with reference to FIG. 2A) may be transferred to the volatile memory 235. In some cases, the portion of the mapping table may be associated with storing address information for the read commands received at 305.

At 340, one or more write commands may be received at the memory system controller 215. In some instances, the write commands may be received from the host system 205 and may be received while the random read benchmark testing operation is ongoing. That is, the random read benchmark testing operation may continue despite receiving one or more write commands.

At 345, data associated with the one or more write commands may be written to the non-volatile memory 220 using the cursor 240. In some examples, the data may be written by the memory system controller 215. The cursor 240 may be associated with writing data to SLCs of the non-volatile memory 220. In some cases, the data associated with the one or more write commands may have been otherwise written to multiple-level cells of the non-volatile memory 220, such that the cursor 245 would have been used to write the data. However, due to the cursor 245 being deallocated, the memory system controller 215 may use the cursor 240 to write the data to SLCs of the non-volatile memory 220. In some examples, the memory system controller 215 may store (e.g., with the data) an indication to move the data to one or more multiple-level cells during a maintenance operation (e.g., during a garbage collection operation).

At 350, a determination that the benchmark test is complete may be made. In some examples, the determination may be made by the memory system controller 215. For example, the benchmark detector may determine that the conditions for performing the benchmark test are no longer satisfied, and therefore the benchmark test is completed.

At 355, one or more maintenance operations may be performed on the data stored in the non-volatile memory 220. In some examples, the one or more maintenance operations may be performed by the memory system controller 215 based on using the cursor 240 to write the data to the non-volatile memory 220. In some cases, performing the maintenance operations may include performing garbage collection processes to read the data from the SLCs and write the data to multiple-level cells of the non-volatile memory 220.

At 360, the portion of the mapping table may be deallocated from the volatile memory 235. In some cases, a portion of the mapping table may remain stored to the volatile memory 235 and the other portion(s) may be transferred to the mapping table stored to the non-volatile memory 220.

At 365, the portion of the mapping table deallocated from the volatile memory 235 may be transferred to the non-volatile memory 220.

At 370, the cursor 245 may be allocated (e.g., reallocated) to the volatile memory 235. Thus, subsequent access operations associated with multiple-level cells may be performed using the cursor 245. For example, after the cursory 245 is reallocated to the volatile memory, the memory system 210 may receive a write command (e.g., a second write command). In some examples, the second write command may be assigned to the cursor 245 for writing the data to a multiple-level cell of the non-volatile memory 220.

At 375, the portion of the mapping table may be stored to the non-volatile memory 220. In some cases, storing the portion of the mapping table may include reallocating a portion of the non-volatile memory 220 to store the portion of the mapping table. As described herein, by increasing the size of the volatile memory 235 for storing address mappings, the latency and overall performance of the memory system 210 may be improved during the benchmark testing operation.

FIG. 4 shows a block diagram 400 of a memory system 420 that supports memory allocation for a benchmark test in accordance with examples as disclosed herein. The memory system 420 may be an example of aspects of a memory system as described with reference to FIGS. 1 through 3. The memory system 420, or various components thereof, may be an example of means for performing various aspects of memory allocation for a benchmark test as described herein. For example, the memory system 420 may include a determination component 425, an allocation component 430, a storing component 435, a read component 440, a reception component 445, an assignment component 450, a transfer component 455, or any combination thereof. Each of these components may communicate, directly or indirectly, with one another (e.g., via one or more buses).

The determination component 425 may be configured as or otherwise support a means for determining, by a memory system including a volatile memory and a non-volatile memory, whether a plurality of read commands are associated with a benchmark testing operation for testing a latency of the memory system, where the volatile memory includes a first portion for storing one or more mappings between logical addresses and physical addresses of the non-volatile memory, a second portion associated with writing to single-level memory cells of the non-volatile memory, and a third portion associated with writing to multiple-level memory cells of the non-volatile memory. The allocation component 430 may be configured as or otherwise support a means for allocating, for a duration associated with performing the benchmark testing operation, the third portion of the volatile memory for storing one or more mappings between logical addresses and physical addresses of the non-volatile memory based at least in part on determining that the plurality of read commands are associated with the benchmark testing operation.

In some examples, the allocation component 430 may be configured as or otherwise support a means for deallocating, for the duration, the third portion of the volatile memory from being associated with writing data to the multiple-level memory cells of the non-volatile memory based at least in part on determining that the plurality of read commands are associated with the benchmark testing operation, where allocating the third portion of the volatile memory for storing one or more mappings between logical addresses and physical addresses of the non-volatile memory is based at least in part on deallocating the third portion of the volatile memory from being associated with writing data to the multiple-level memory cells of the non-volatile memory.

In some examples, to support deallocating the third portion of the volatile memory from being associated with writing data to the multiple-level memory cells of the non-volatile memory, the storing component 435 may be configured as or otherwise support a means for storing data associated with the third portion of the volatile memory to the non-volatile memory.

In some examples, the allocation component 430 may be configured as or otherwise support a means for deallocating, after the duration, the third portion of the volatile memory from being associated with storing one or more mappings between logical addresses and physical addresses of the non-volatile memory. In some examples, the allocation component 430 may be configured as or otherwise support a means for allocating the third portion of the volatile memory for being associated with writing data to the multiple-level memory cells of the non-volatile memory based at least in part on deallocating the third portion of the volatile memory from being associated with storing one or more mappings between logical addresses and physical addresses of the non-volatile memory.

In some examples, the storing component 435 may be configured as or otherwise support a means for storing, to the third portion of the volatile memory, mappings between logical addresses associated with the plurality of read commands and respective physical addresses of the non-volatile memory based at least in part on allocating the third portion of the volatile memory for storing one or more mappings between logical addresses and physical addresses of the non-volatile memory. In some examples, the read component 440 may be configured as or otherwise support a means for reading data from the respective physical addresses of the non-volatile memory based at least in part on storing the mappings between logical addresses associated with the plurality of read commands and respective physical addresses of the non-volatile memory.

In some examples, the determination component 425 may be configured as or otherwise support a means for determining that the plurality of read commands are sequential read commands. In some examples, the allocation component 430 may be configured as or otherwise support a means for preloading, to the third portion of the volatile memory, mappings between one or more subsequent logical addresses and respective physical addresses of the non-volatile memory based at least in part on determining that the plurality of read commands are sequential read commands.

In some examples, the reception component 445 may be configured as or otherwise support a means for receiving, by the memory system, a first write command during the duration. In some examples, the assignment component 450 may be configured as or otherwise support a means for assigning the first write command to the second portion of the volatile memory based at least in part on receiving the first write command during the duration, where first data associated with the first write command is written to one or more single-level memory cells of the non-volatile memory based at least in part on assigning the first write command to the second portion of the volatile memory.

In some examples, the transfer component 455 may be configured as or otherwise support a means for transferring, during a maintenance operation occurring after the duration, the first data from the one or more single-level memory cells of the non-volatile memory to one or more multiple-level memory cells of the non-volatile memory.

In some examples, the reception component 445 may be configured as or otherwise support a means for receiving, by the memory system, a second write command after the duration. In some examples, the assignment component 450 may be configured as or otherwise support a means for assigning the second write command to the third portion of the volatile memory based at least in part on receiving the second write command after the duration, where second data associated with the second write command is written to one or more multiple-level memory cells of the non-volatile memory based at least in part on assigning the second write command to the third portion of the volatile memory.

In some examples, to support determining that the plurality of read commands are associated with the benchmark testing operation, the determination component 425 may be configured as or otherwise support a means for determining that a threshold quantity of read commands are received within a second duration.

In some examples, to support determining that the plurality of read commands are associated with the benchmark testing operation, the determination component 425 may be configured as or otherwise support a means for determining that logical block addresses associated with each read command of the plurality of read commands are non-contiguous.

In some examples, to support determining that the plurality of read commands are associated with the benchmark testing operation, the determination component 425 may be configured as or otherwise support a means for determining that each read command of the plurality of read commands is associated with a same size of data.

In some examples, to support determining that the plurality of read commands are associated with the benchmark testing operation, the determination component 425 may be configured as or otherwise support a means for determining that the plurality of read commands are received without a write command, a power management command, or both, being interleaved in the plurality of read commands.

In some examples, the third portion of the volatile memory is associated with writing to a redundant array of independent non-volatile memory cells.

In some examples, a size of the third portion of the volatile memory is greater than a size of the second portion of the volatile memory.

FIG. 5 shows a flowchart illustrating a method 500 that supports memory allocation for a benchmark test in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the wireless memory system may perform aspects of the described functions using special-purpose hardware.

At 505, the method may include determining, by a memory system including a volatile memory and a non-volatile memory, whether a plurality of read commands are associated with a benchmark testing operation for testing a latency of the memory system, where the volatile memory includes a first portion for storing one or more mappings between logical addresses and physical addresses of the non-volatile memory, a second portion associated with writing to single-level memory cells of the non-volatile memory, and a third portion associated with writing to multiple-level memory cells of the non-volatile memory. The operations of 505 may be performed in accordance with examples as disclosed herein. In some examples, aspects of the operations of 505 may be performed by a determination component 425 as described with reference to FIG. 4.

At 510, the method may include allocating, for a duration associated with performing the benchmark testing operation, the third portion of the volatile memory for storing one or more mappings between logical addresses and physical addresses of the non-volatile memory based at least in part on determining that the plurality of read commands are associated with the benchmark testing operation. The operations of 510 may be performed in accordance with examples as disclosed herein. In some examples, aspects of the operations of 510 may be performed by an allocation component 430 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for determining, by a memory system including a volatile memory and a non-volatile memory, whether a plurality of read commands are associated with a benchmark testing operation for testing a latency of the memory system, where the volatile memory includes a first portion for storing one or more mappings between logical addresses and physical addresses of the non-volatile memory, a second portion associated with writing to single-level memory cells of the non-volatile memory, and a third portion associated with writing to multiple-level memory cells of the non-volatile memory and allocating, for a duration associated with performing the benchmark testing operation, the third portion of the volatile memory for storing one or more mappings between logical addresses and physical addresses of the non-volatile memory based at least in part on determining that the plurality of read commands are associated with the benchmark testing operation.

Aspect 2: The method, apparatus, or non-transitory computer-readable medium of aspect 1, further including operations, features, circuitry, logic, means, or instructions, or any combination thereof for deallocating, for the duration, the third portion of the volatile memory from being associated with writing data to the multiple-level memory cells of the non-volatile memory based at least in part on determining that the plurality of read commands are associated with the benchmark testing operation, where allocating the third portion of the volatile memory for storing one or more mappings between logical addresses and physical addresses of the non-volatile memory is based at least in part on deallocating the third portion of the volatile memory from being associated with writing data to the multiple-level memory cells of the non-volatile memory.

Aspect 3: The method, apparatus, or non-transitory computer-readable medium of aspect 2, where deallocating the third portion of the volatile memory from being associated with writing data to the multiple-level memory cells of the non-volatile memory includes operations, features, circuitry, logic, means, or instructions, or any combination thereof for storing data associated with the third portion of the volatile memory to the non-volatile memory.

Aspect 4: The method, apparatus, or non-transitory computer-readable medium of any of aspects 1 through 3, further including operations, features, circuitry, logic, means, or instructions, or any combination thereof for deallocating, after the duration, the third portion of the volatile memory from being associated with storing one or more mappings between logical addresses and physical addresses of the non-volatile memory and allocating the third portion of the volatile memory for being associated with writing data to the multiple-level memory cells of the non-volatile memory based at least in part on deallocating the third portion of the volatile memory from being associated with storing one or more mappings between logical addresses and physical addresses of the non-volatile memory.

Aspect 5: The method, apparatus, or non-transitory computer-readable medium of any of aspects 1 through 4, further including operations, features, circuitry, logic, means, or instructions, or any combination thereof for storing, to the third portion of the volatile memory, mappings between logical addresses associated with the plurality of read commands and respective physical addresses of the non-volatile memory based at least in part on allocating the third portion of the volatile memory for storing one or more mappings between logical addresses and physical addresses of the non-volatile memory and reading data from the respective physical addresses of the non-volatile memory based at least in part on storing the mappings between logical addresses associated with the plurality of read commands and respective physical addresses of the non-volatile memory.

Aspect 6: The method, apparatus, or non-transitory computer-readable medium of any of aspects 1 through 5, further including operations, features, circuitry, logic, means, or instructions, or any combination thereof for determining that the plurality of read commands are sequential read commands and preloading, to the third portion of the volatile memory, mappings between one or more subsequent logical addresses and respective physical addresses of the non-volatile memory based at least in part on determining that the plurality of read commands are sequential read commands.

Aspect 7: The method, apparatus, or non-transitory computer-readable medium of any of aspects 1 through 6, further including operations, features, circuitry, logic, means, or instructions, or any combination thereof for receiving, by the memory system, a first write command during the duration and assigning the first write command to the second portion of the volatile memory based at least in part on receiving the first write command during the duration, where first data associated with the first write command is written to one or more single-level memory cells of the non-volatile memory based at least in part on assigning the first write command to the second portion of the volatile memory.

Aspect 8: The method, apparatus, or non-transitory computer-readable medium of aspect 7, further including operations, features, circuitry, logic, means, or instructions, or any combination thereof for transferring, during a maintenance operation occurring after the duration, the first data from the one or more single-level memory cells of the non-volatile memory to one or more multiple-level memory cells of the non-volatile memory.

Aspect 9: The method, apparatus, or non-transitory computer-readable medium of any of aspects 1 through 8, further including operations, features, circuitry, logic, means, or instructions, or any combination thereof for receiving, by the memory system, a second write command after the duration and assigning the second write command to the third portion of the volatile memory based at least in part on receiving the second write command after the duration, where second data associated with the second write command is written to one or more multiple-level memory cells of the non-volatile memory based at least in part on assigning the second write command to the third portion of the volatile memory.

Aspect 10: The method, apparatus, or non-transitory computer-readable medium of any of aspects 1 through 9, where determining that the plurality of read commands are associated with the benchmark testing operation includes operations, features, circuitry, logic, means, or instructions, or any combination thereof for determining that a threshold quantity of read commands are received within a second duration.

Aspect 11: The method, apparatus, or non-transitory computer-readable medium of any of aspects 1 through 10, where determining that the plurality of read commands are associated with the benchmark testing operation includes operations, features, circuitry, logic, means, or instructions, or any combination thereof for determining that logical block addresses associated with each read command of the plurality of read commands are non-contiguous.

Aspect 12: The method, apparatus, or non-transitory computer-readable medium of any of aspects 1 through 11, where determining that the plurality of read commands are associated with the benchmark testing operation includes operations, features, circuitry, logic, means, or instructions, or any combination thereof for determining that each read command of the plurality of read commands is associated with a same size of data.

Aspect 13: The method, apparatus, or non-transitory computer-readable medium of any of aspects 1 through 12, where determining that the plurality of read commands are associated with the benchmark testing operation includes operations, features, circuitry, logic, means, or instructions, or any combination thereof for determining that the plurality of read commands are received without a write command, a power management command, or both, being interleaved in the plurality of read commands.

Aspect 14: The method, apparatus, or non-transitory computer-readable medium of any of aspects 1 through 13, where the third portion of the volatile memory is associated with writing to a redundant array of independent non-volatile memory cells.

Aspect 15: The method, apparatus, or non-transitory computer-readable medium of any of aspects 1 through 14, where a size of the third portion of the volatile memory is greater than a size of the second portion of the volatile memory.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a memory system comprising a volatile memory and a non-volatile memory; and
a controller coupled with the memory system and configured to cause the apparatus to:
determine whether a plurality of read commands are associated with a benchmark testing operation for testing a latency of the memory system, wherein the volatile memory comprises a first portion for storing one or more mappings between logical addresses and physical addresses of the non-volatile memory, a second portion associated with writing to single-level memory cells of the non-volatile memory, and a third portion associated with writing to multiple-level memory cells of the non-volatile memory; and
allocate, for a duration associated with performing the benchmark testing operation, the third portion of the volatile memory for storing one or more mappings between logical addresses and physical addresses of the non-volatile memory based at least in part on determining that the plurality of read commands are associated with the benchmark testing operation.

2. The apparatus of claim 1, wherein the controller is further configured to cause the apparatus to:
deallocate, for the duration, the third portion of the volatile memory from being associated with writing data to the multiple-level memory cells of the non-volatile memory based at least in part on determining that the plurality of read commands are associated with the benchmark testing operation, wherein allocating the third portion of the volatile memory for storing one or more mappings between logical addresses and physical addresses of the non-volatile memory is based at least in part on deallocating the third portion of the volatile memory from being associated with writing data to the multiple-level memory cells of the non-volatile memory.

3. The apparatus of claim 2, wherein deallocating the third portion of the volatile memory from being associated with writing data to the multiple-level memory cells of the non-volatile memory is configured to cause the apparatus to:
store data associated with the third portion of the volatile memory to the non-volatile memory.

4. The apparatus of claim 1, wherein the controller is further configured to cause the apparatus to:
deallocate, after the duration, the third portion of the volatile memory from being associated with storing one or more mappings between logical addresses and physical addresses of the non-volatile memory; and
allocate the third portion of the volatile memory for being associated with writing data to the multiple-level memory cells of the non-volatile memory based at least in part on deallocating the third portion of the volatile memory from being associated with storing one or more mappings between logical addresses and physical addresses of the non-volatile memory.

5. The apparatus of claim 1, wherein the controller is further configured to cause the apparatus to:
store, to the third portion of the volatile memory, mappings between logical addresses associated with the plurality of read commands and respective physical addresses of the non-volatile memory based at least in part on allocating the third portion of the volatile memory for storing one or more mappings between logical addresses and physical addresses of the non-volatile memory; and
read data from the respective physical addresses of the non-volatile memory based at least in part on storing the mappings between logical addresses associated with the plurality of read commands and respective physical addresses of the non-volatile memory.

6. The apparatus of claim 1, wherein the controller is further configured to cause the apparatus to:
determine that the plurality of read commands are sequential read commands; and
preload, to the third portion of the volatile memory, mappings between one or more subsequent logical addresses and respective physical addresses of the non-volatile memory based at least in part on determining that the plurality of read commands are sequential read commands.

7. The apparatus of claim 1, wherein the controller is further configured to cause the apparatus to:
receive, by the memory system, a first write command during the duration; and
assign the first write command to the second portion of the volatile memory based at least in part on receiving the first write command during the duration, wherein first data associated with the first write command is written to one or more single-level memory cells of the non-volatile memory based at least in part on assigning the first write command to the second portion of the volatile memory.

8. The apparatus of claim 7, wherein the controller is further configured to cause the apparatus to:
transfer, during a maintenance operation occurring after the duration, the first data from the one or more single-level memory cells of the non-volatile memory to one or more multiple-level memory cells of the non-volatile memory.

9. The apparatus of claim 1, wherein the controller is further configured to cause the apparatus to:
receive, by the memory system, a second write command after the duration; and
assign the second write command to the third portion of the volatile memory based at least in part on receiving the second write command after the duration, wherein second data associated with the second write command is written to one or more multiple-level memory cells of the non-volatile memory based at least in part on assigning the second write command to the third portion of the volatile memory.

10. The apparatus of claim 1, wherein determining that the plurality of read commands are associated with the benchmark testing operation is configured to cause the apparatus to:
determine that a threshold quantity of read commands are received within a second duration.

11. The apparatus of claim 1, wherein determining that the plurality of read commands are associated with the benchmark testing operation is configured to cause the apparatus to:
determine that logical block addresses associated with each read command of the plurality of read commands are non-contiguous.

12. The apparatus of claim 1, wherein determining that the plurality of read commands are associated with the benchmark testing operation is configured to cause the apparatus to:
determine that each read command of the plurality of read commands is associated with a same size of data.

13. The apparatus of claim 1, wherein determining that the plurality of read commands are associated with the benchmark testing operation is configured to cause the apparatus to:
determine that the plurality of read commands are received without a write command, a power management command, or both, being interleaved in the plurality of read commands.

14. The apparatus of claim 1, wherein the third portion of the volatile memory is associated with writing to a redundant array of independent non-volatile memory cells.

15. The apparatus of claim 1, wherein a size of the third portion of the volatile memory is greater than a size of the second portion of the volatile memory.

16. A non-transitory computer-readable medium storing code comprising instructions which, when executable by a processor of an electronic device, cause the electronic device to:
determine, by a memory system comprising a volatile memory and a non-volatile memory, whether a plurality of read commands are associated with a benchmark testing operation for testing a latency of the memory system, wherein the volatile memory comprises a first portion for storing one or more mappings between logical addresses and physical addresses of the non-volatile memory, a second portion associated with writing to single-level memory cells of the non-volatile memory, and a third portion associated with writing to multiple-level memory cells of the non-volatile memory; and
allocate, for a duration associated with performing the benchmark testing operation, the third portion of the volatile memory for storing one or more mappings between logical addresses and physical addresses of the non-volatile memory based at least in part on determining that the plurality of read commands are associated with the benchmark testing operation.

17. The non-transitory computer-readable medium of claim 16, wherein the instructions, when executed by the processor of the electronic device, further cause the electronic device to:
deallocate, for the duration, the third portion of the volatile memory from being associated with writing data to the multiple-level memory cells of the non-volatile memory based at least in part on determining that the plurality of read commands are associated with the benchmark testing operation, wherein allocating the third portion of the volatile memory for storing one or more mappings between logical addresses and physical addresses of the non-volatile memory is based at least in part on deallocating the third portion of the volatile memory from being associated with writing data to the multiple-level memory cells of the non-volatile memory.

18. The non-transitory computer-readable medium of claim 16, wherein the instructions, when executed by the processor of the electronic device, further cause the electronic device to:
deallocate, after the duration, the third portion of the volatile memory from being associated with storing one or more mappings between logical addresses and physical addresses of the non-volatile memory; and
allocate the third portion of the volatile memory for being associated with writing data to the multiple-level memory cells of the non-volatile memory based at least in part on deallocating the third portion of the volatile memory from being associated with storing one or more mappings between logical addresses and physical addresses of the non-volatile memory.

19. The non-transitory computer-readable medium of claim 16, wherein the instructions, when executed by the processor of the electronic device, further cause the electronic device to:
store, to the third portion of the volatile memory, mappings between logical addresses associated with the plurality of read commands and respective physical addresses of the non-volatile memory based at least in part on allocating the third portion of the volatile memory for storing one or more mappings between logical addresses and physical addresses of the non-volatile memory; and
read data from the respective physical addresses of the non-volatile memory based at least in part on storing the mappings between logical addresses associated with the plurality of read commands and respective physical addresses of the non-volatile memory.

20. A method, comprising:
determining, by a memory system comprising a volatile memory and a non-volatile memory, whether a plurality of read commands are associated with a benchmark testing operation for testing a latency of the memory system, wherein the volatile memory comprises a first portion for storing one or more mappings between logical addresses and physical addresses of the non-volatile memory, a second portion associated with writing to single-level memory cells of the non-volatile memory, and a third portion associated with writing to multiple-level memory cells of the non-volatile memory; and
allocating, for a duration associated with performing the benchmark testing operation, the third portion of the volatile memory for storing one or more mappings between logical addresses and physical addresses of the non-volatile memory based at least in part on determining that the plurality of read commands are associated with the benchmark testing operation.

21. The method of claim 20, further comprising:
deallocating, for the duration, the third portion of the volatile memory from being associated with writing data to the multiple-level memory cells of the non-volatile memory based at least in part on determining that the plurality of read commands are associated with the benchmark testing operation, wherein allocating the third portion of the volatile memory for storing one or more mappings between logical addresses and physical addresses of the non-volatile memory is based at least in part on deallocating the third portion of the volatile memory from being associated with writing data to the multiple-level memory cells of the non-volatile memory.

22. The method of claim 21, wherein deallocating the third portion of the volatile memory from being associated with writing data to the multiple-level memory cells of the non-volatile memory comprises:
storing data associated with the third portion of the volatile memory to the non-volatile memory.

23. The method of claim 20, further comprising:
deallocating, after the duration, the third portion of the volatile memory from being associated with storing one or more mappings between logical addresses and physical addresses of the non-volatile memory; and
allocating the third portion of the volatile memory for being associated with writing data to the multiple-level memory cells of the non-volatile memory based at least in part on deallocating the third portion of the volatile memory from being associated with storing one or more mappings between logical addresses and physical addresses of the non-volatile memory.

24. The method of claim 20, further comprising:
storing, to the third portion of the volatile memory, mappings between logical addresses associated with the plurality of read commands and respective physical addresses of the non-volatile memory based at least in part on allocating the third portion of the volatile memory for storing one or more mappings between logical addresses and physical addresses of the non-volatile memory; and
reading data from the respective physical addresses of the non-volatile memory based at least in part on storing the mappings between logical addresses associated with the plurality of read commands and respective physical addresses of the non-volatile memory.

25. The method of claim 20, further comprising:
determining that the plurality of read commands are sequential read commands; and
preloading, to the third portion of the volatile memory, mappings between one or more subsequent logical addresses and respective physical addresses of the non-volatile memory based at least in part on determining that the plurality of read commands are sequential read commands.
